(19) United States
(12) Patent Application Publication
(10) Pub. No.: US 2025/0019501 A1
(43) Pub. Date: Jan. 16, 2025

(54) ALGAE RESISTANT POLYMER-BASED GRANULES FOR ASPHALT SHINGLES

(71) Applicant: Owens Corning Intellectual Capital, LLC, Toledo, OH (US)

(72) Inventors: Nardine Said Abadeer, Columbus, OH (US); Kevin Andrew Click, Glenford, OH (US); William Edwin Smith, Pataskala, OH (US)

(21) Appl. No.: 18/755,013

(22) Filed: Jun. 26, 2024

Related U.S. Application Data
(60) Provisional application No. 63/513,209, filed on Jul. 12, 2023.

(51) Int. Cl. C08J 3/12; C08K 3/22; C08K 3/26; E04D 1/00; E04D 1/20

(52) U.S. Cl. CPC C08J 3/12; C08K 3/22; C08K 3/26; E04D 1/00; E04D 1/20; C08J 2323/12; C08K 2003/2248; C08K 2003/2296; C08K 2003/265; C08K 2201/005; E04D 2001/005

(57) ABSTRACT

Various embodiments described herein are directed algae resistant polymer-based granules and uses thereof. In various embodiments presented herein, the polymer-based granules include an algaecide, a biocide, a fungicide, an antimicrobial compound, or a mixture thereof in combination with a polymer carrier and, optionally, a filler. The resultant polymer-based granules include a precise balance between polymer carrier, filler, and functional additive to achieve a particular leach rate of the functional additive after 3000 hours of aging according to ASTM D4798.

### CROSS-REFERENCE TO RELATED APPLICATIONS

This application claims priority to and all benefit of U.S. Provisional Patent Application No. 63/513,209, filed on Jul. 12, 2023, the entire disclosure of which is fully incorporated herein by reference.

### BACKGROUND

Asphalt-based roofing materials, such as roofing shingles, are installed on the roofs of buildings to provide protection from the elements. Typically, the roofing material includes a substrate, an asphalt coating on the substrate, and a surface layer of granules embedded in the asphalt coating.

In many climates, particularly climates that are warm with high humidity, algae, cyanobacteria, moss, fungus, and other microorganisms may grow on the exposed surfaces of the roofing material. The growth of algae, cyanobacteria, moss, fungus, and other microorganisms can lead to a discoloring of the exposed roofing surfaces. Although the discoloration may begin as dark spots, it can develop over time into dark streaks and eventually cover a majority of the roof. This discoloring can be particularly noticeable on light-colored or white roofing materials, which are often used in warm and humid climates because of their solar reflective properties.

Conventionally, specialized granules are included on the surface of the roofing material to combat the growth of algae, cyanobacteria, moss, and/or fungus. The granules are conventionally either composed primarily of or coated with a coating containing copper, zinc, or other metals. When wetted by the rain, the metallic compounds leach out from the roofing material and act as algaecides, biocides, and/or fungicides.

However, the metallic materials can be very expensive and increase the overall cost of the roofing material. Moreover, the metal is present mainly on the surface of the granules, resulting in a high metal leaching rate in the beginning and a shorter overall time of effectiveness. Accordingly, there is a need for alternative algae resistant roofing materials.

### BRIEF SUMMARY

Various embodiments described herein are directed algae resistant polymer-based granules and uses thereof. In various embodiments presented herein, the polymer-based granules are include an algaecide, a biocide, a fungicide, an antimicrobial compound, or a mixture thereof in combination with a polymer carrier and, optionally, a filler. The resultant polymer-based granules include a precise balance between polymer carrier, filler, and functional additive to achieve a particular leach rate of the functional additive after 3000 hours of aging according to ASTM D4798.

According to various embodiments, a polymer-based granule comprises: at least 20 wt. %, based on a total weight of the polymer-based granule, of a polyolefin carrier material; from 1 wt. % to 10 wt. %, based on a total weight of the polymer-based granule, of a functional additive comprising one or more of an algaecide, biocide, fungicide, and antimicrobial compound; from 1 wt. % to less than 80 wt. % of a filler, based on a total weight of the polymer-based granule, wherein the filler comprises a plurality of particles having a median particle size of from 1 to 5 microns, as measured in accordance with ISO 13322-2; and from 0.25 wt. % to 5 wt. % of a UV blocking agent. The polymer-based granules leach less than 100 ppm of functional additive per gram of the polymer-based granule after 3000 hours of aging according to ASTM D4798.

In various embodiments, a polymer-based granule comprises: at least 60 wt. %, based on a total weight of the polymer-based granule, of a polyolefin carrier material; from 1 wt. % to 10 wt. %, based on a total weight of the polymer-based granule, of a functional additive comprising one or more of an algaecide, biocide, fungicide, and antimicrobial compound; from 5 to less than 40 wt. % of a filler, based on a total weight of the polymer-based granule, wherein the filler comprises a plurality of particles having a median particle size of from 1 to 5 microns, as measured in accordance with ISO 13322-2; and from 0.25 wt. % to 5 wt. %, based on a total weight of the polymer-based granule, of a UV blocking agent. The polymer-based granules leach less than 100 ppm of functional additive per gram of the polymer-based granule after 3000 hours of aging according to ASTM D4798.

According to various embodiments, a polymer-based granule comprises: at least 20 wt. %, based on a total weight of the polymer-based granule, of a polyolefin carrier material; from 1 wt. % to 10 wt. %, based on a total weight of the polymer-based granule, of a functional additive comprising one or more of an algaecide, biocide, fungicide, and antimicrobial compound; and from 1 wt. % to less than 80 wt. % of a filler, based on a total weight of the polymer-based granule. In addition, (i) the filler comprises a plurality of particles having a median particle size of greater than 5 microns, as measured in accordance with ISO 13322-2; (ii) the polyolefin carrier material comprises polypropylene; or (iii) the filler comprises a plurality of particles having a median particle size of greater than 5 microns, as measured in accordance with ISO 13322-2, and the polyolefin carrier material comprises polypropylene. In such embodiments, the polymer-based granules leach greater than 100 ppm of functional additive per gram of the polymer-based granule after 3000 hours of aging according to ASTM D4798.

In further embodiments, a polymer-based granule comprises: at least 60 wt. % of a polyolefin carrier material, based on a total weight of the polymer-based granule; from 1 wt. % to 10 wt. %, based on a total weight of the polymer-based granule, of a functional additive comprising one or more of an algaecide, biocide, fungicide, and antimicrobial compound; and from 5 wt. % to less than 40 wt. % of a filler, based on a total weight of the polymer-based granule. In addition, (i) the filler comprises a plurality of particles having a median particle size of greater than 5 microns, as measured in accordance with ISO 13322-2; (ii) the polyolefin carrier material comprises polypropylene; or (iii) the filler comprises a plurality of particles having a median particle size of greater than 5 microns, as measured in accordance with ISO 13322-2, and the polyolefin carrier material comprises polypropylene. In such embodiments, the polymer-based granules leach greater than 100 ppm of functional additive per gram of the polymer-based granule after 3000 hours of aging according to ASTM D4798.

Various embodiments described herein provide a method of adjusting the functionality of a polymer-based granule, the method comprising forming a polymer-based granule by combining: at least 20 wt. %, based on the total weight of the polymer-based granule, of a polyolefin carrier material; from 1 wt. % to 10 wt. %, based on the total weight of the polymer-based granule, of at least one functional additive comprising one or more of an algaecide, biocide, fungicide, and antimicrobial compound; and from 1 wt. % to less than 80 wt. % of a filler, based on a total weight of the polymer-based granule. The method further comprises adjusting a functional additive leach rate to achieve a leach rate of less than 100 ppm of functional additive per gram of the polymer-based granule after 3000 hours of aging according to ASTM D4798 by performing at least one of the following steps: forming the polymer-based granule with a polyethylene polymer carrier material; incorporating at least 0.25 wt. % of a UV blocking agent in the polymer-based granule; or utilizing a filler having a median particle size of 1 to 5 microns, as measured in accordance with ISO 13322-2.

Various embodiments described herein provide a method of adjusting the functionality of a polymer-based granule, the method comprising forming a polymer-based granule by combining: forming a polymer-based granule by combining: at least 60 wt. %, based on the total weight of the polymer-based granule, of a polyolefin carrier material; from 1 wt. % to 10 wt. %, based on the total weight of the polymer-based granule, of at least one functional additive comprising one or more of an algaecide, biocide, fungicide, and antimicrobial compound; and from 5 wt. % to less than 40 wt. % of a filler, based on a total weight of the polymer-based granule. The method further comprises adjusting a functional additive leach rate to achieve a leach rate of less than 100 ppm of functional additive per gram of the polymer-based granule after 3000 hours of aging according to ASTM D4798 by performing at least one of the following steps: forming the polymer-based granule with a polyethylene polymer carrier material; incorporating at least 0.25 wt. % of a UV blocking agent in the polymer-based granule; or utilizing a filler having a median particle size of 1 to 5 microns, as measured in accordance with ISO 13322-2.

Additionally, various embodiments provide a method of adjusting the functionality of a polymer-based granule, the method comprising forming a polymer-based granule by combining: at least 20 wt. %, based on a total weight of the polymer-based granule, of a polyolefin carrier material; from 1 wt. % to 10 wt. %, based on a total weight of the polymer-based granule, of at least one functional additive comprising one or more of an algaecide, biocide, fungicide, and antimicrobial compound; and from 1 wt. % to less than 80 wt. % of a filler, based on a total weight of the polymer-based granule. The method further comprises adjusting a functional additive leach rate to achieve a leach rate of greater than 100 ppm of functional additive per gram of the polymer-based granule after 3000 hours of aging according to ASTM D4798 by performing at least one of the following steps: forming the polymer-based granule with a polypropylene polymer carrier material; or utilizing a filler having a median particle size greater than 5 microns, as measured in accordance with ISO 13322-2.

Various embodiments described herein provide a method of adjusting the functionality of a polymer-based granule, the method comprising forming a polymer-based granule by combining: at least 60 wt. %, based on a total weight of the polymer-based granule, of a polyolefin carrier material; from 1 wt. % to 10 wt. %, based on a total weight of the polymer-based granule, of at least one functional additive comprising one or more of an algaecide, biocide, fungicide, and antimicrobial compound; and from 5 wt. % to less than 40 wt. % of a filler, based on a total weight of the polymer-based granule. The method further comprises adjusting a functional additive leach rate to achieve a leach rate of greater than 100 ppm of functional additive per gram of the polymer-based granule after 3000 hours of aging according to ASTM D4798 by performing at least one of the following steps: forming the polymer-based granule with a polypropylene polymer carrier material; or utilizing a filler having a median particle size greater than 5 microns, as measured in accordance with ISO 13322-2.

### BRIEF DESCRIPTION OF THE DRAWINGS

The general inventive concepts, as well as embodiments and advantages thereof, are described in greater detail, by way of example, with reference to the drawings in which:

FIG. 1 is a schematic elevation view of an apparatus for making shingles according to one or more embodiments shown and described herein;

FIG. 2 is a perspective view of a laminated shingle formed on the apparatus of FIG. 1 and including a polymer-based granule according to one or more embodiments shown and described herein; and

FIG. 3 graphically illustrates the functional additive leach rate (ppm CuO/g of pellet) over various hours of aging according to ASTM D4798.

### DETAILED DESCRIPTION

Several illustrative embodiments will be described in detail with the understanding that the present disclosure merely exemplifies the general inventive concepts. Embodiments encompassing the general inventive concepts may take various forms and the general inventive concepts are not intended to be limited to the specific embodiments described herein.

The general inventive concepts encompass algae resistant polymer-based granules and uses thereof, such as for roofing products, outdoor building materials, and the like. In various embodiments presented herein, the polymer-based granules are formed from a coextrusion of a polymer carrier with a powder mixture including at least one functional additive and, optionally, a filler. The functional additive is an algaecide, a biocide, a fungicide, an antimicrobial compound, or a mixture thereof. When present, the filler is included in the polymer-based granules in an amount of from about 1 wt. % to about 80 wt. % or from about 5 wt. % to about 40 wt. %, based on a total weight of the polymer-based granules. The resultant polymer-based granules include a precise balance between polymer carrier, filler, and functional additive to achieve a particular leach rate of the functional additive after 3000 hours of aging according to ASTM D4798.

The polymer-based granules include a polymer carrier that functions to bind the pellets together. The polymer carrier can include homopolymers or copolymers that are linear or branched. The polymer carrier may further include biodegradable polymers or copolymers, bio-sourced polymers, and/or recycled polymers. Copolymers can be random, alternating, or block. Examples of polymeric compounds include acrylic copolymers, polyesters, polyamides, epoxies, nonacid-containing polyolefins, polyolefin alloys, polypropylene, acid-containing polyolefins, polyvinyl chloride, polyester block amide, ethylene-chlorotrifluoroethylene, nylons, polyvinylidene fluoride, polycarbonates, polyanhydrides, poly(ortho esters), polyphosphoesters, and combinations thereof. In any of the aspects disclosed herein, the polymer carrier may include a thermoplastic or thermoset polymeric material. In any of the embodiments, the polymeric carriers may be selected from high density, ultra-high density, low density, and linear low density polyethylene, polypropylene, low and high impact polystyrene, PVC, ABS, polyamides, polyesters, polycarbonate, polyvinyl chloride, polymethyl methacrylate, polyglycolic acid, polyhydroxy butyrate, polyurethanes, polyureas, epoxy, polydimethylsiloxane (PDMS), poly(styrene-butadiene-styrene) (SBS), styrene butadiene rubber (SBR), styrene-(ethylene/butylene)-crystalline block copolymer (SEBC), fluoropolymers (e.g., polytetrafluoroethylene, polyvinylidene fluoride, and fluorinated ethylene propylene), imides (e.g., polyimide and polyether imide), nylons (e.g., Nylon 6 and Nylon 12), and acrylics. Biodegradable polymers suitable for use as polymeric carriers can include polyhydroxyalkanoates, poly(latic acid), polyhydroxybutyrate-co-hydoryvalerate, gellan gum, curdlan, amylose, amylopectine, starch-based polymers such as polysaccharides, chitin, cellulose acetate, polycaprolactone, poly(butylene succinate-co-butylene adipate), poly(butylene succinate), and combinations and derivatives thereof. In embodiments, non-biodegradable polymers may be included as polymeric carriers in combination with additives that allow the polymers to biodegrade. Polymeric carriers can also be selected from polyethylene terephthalate, atactic polypropylene, polyvinyl butyral, asphalt, recycled asphalt, and combinations thereof. In any of the exemplary embodiments, the polymer carrier may be a polyolefin carrier and include polyethylene, such as low-density polyethylene, or polypropylene.

The selection of the polymer carrier can be used to control the amount of leaching of the functional additive from the polymer-based granules. For example, selection of a polymer carrier having a high UV resistance or low oxidation rate can be used to reduce the leach rate of the functional additive, while selection of a polymer carrier having a low UV resistance or high oxidation rate can be used to increase the leach rate of the functional additive relative to a comparative granule. More particularly, it is believed that the UV resistance or oxidation rate of the polymer correlate with the rate of degradation of the polymer carrier, which in turn correlates with the leach rate of the functional additive. In other words, a lower UV resistance allows the polymer carrier to degrade faster, thereby increasing the rate at which the functional additive is leached from the polymer-based granules. In contrast, a higher UV resistance prevents the polymer from degradation, reducing the degradation of the polymer and reducing the leaching rate of the functional additive from the polymer-based granules.

For instance, in embodiments in which the polymer-based granules are formed with a polymer carrier material having high UV resistance or low oxidation rate, such as polyethylene, the polymer-based granules may leach less than 100 ppm of functional additive per gram of polymer-based granule after 3000 hours of aging in accordance with ASTM D4798. In embodiments in which the polymer-based granules are formed with a polymer carrier material having low UV resistance or high oxidation rate, such as polypropylene, the polymer-based granules may leach greater than 100 ppm of functional additive per gram of polymer-based granule after 3000 hours of aging in accordance with ASTM D4798. As will be discussed in greater detail below, other components (e.g., the additives incorporated into the polymer-based granules, the solubility of the filler, and the particle size of the filler) of the polymer-based granules can be selected to further adjust the amount of leaching of the functional additive from the polymer-based granules.

The polymer carrier is included in the polymer-based granules in an amount greater than about 20 wt. %, greater than about 30 wt. %, greater than about 40 wt. %, greater than about 50 wt. %, or greater than about 60 wt. %, including, for example, greater than about 65 wt. %, greater than about 70 wt. %, greater than about 75 wt. %, greater than about 80 wt. %, greater than about 85 wt. %, greater than about 90 wt. %, greater than about 91 wt. %, greater than about 92 wt. %, or greater than about 93 wt. %, based on a total weight of the polymer-based granules, including all numbers and end points therebetween. Additionally, the polymer carrier can be included in an amount less than about 94 wt. %, less than about 90 wt. %, less than about 85 wt. %, less than about 80 wt. %, less than about 75 wt. %, or less than about 70 wt. % based on a total weight of the polymer granules, including all numbers and end points therebetween. For example, the polymer carrier can be present in the polymer-based granules in an amount of from about 40 wt. % to about 93 wt. %, including, for example, from about 40 wt. % to about 85 wt. %, from about 40 wt. % to about 80 wt. %, from about 50 wt. % to about 93 wt. %, from about 50 wt. % to about 85 wt. %, from about 50 wt. % to about 80 wt. %, from about 60 wt. % to about 93 wt. %, from about 60 wt. % to about 85 wt. %, from about 60 wt. % to about 80 wt. %, from about 70 wt. % to about 93 wt. %, from about 70 wt. % to about 85 wt. %, from about 70 wt. % to about 80 wt. %, from about 75 wt. % to about 93 wt. %, from about 75 wt. % to about 85 wt. %, or from about 75 wt. % to about 80 wt. %, including any ranges or subranges therein.

In any of the embodiments, the polymer carrier may be coextruded with a mixture including the filler and the at least one functional additive. The functional additive can be any functional additive capable of imparting a desired property into the polymer-based granule. In any of the embodiments, the functional additive may be capable of at least imparting resistance to algae, cyanobacteria, moss, fungus, and/or other microorganisms to the polymer-based granules. By way of non-limiting example, the functional additive can be an algaecide, a biocide, a fungicide, an antimicrobial compound, or mixtures thereof. In some embodiments, the functional additive comprises copper oxide, zinc oxide, or a mixture thereof. In some embodiments, the functional additive includes oxides, powders, alloys, salts, or organo-metallic compounds of copper, lead, zinc, tin, silver, iron, or nickel. Metal materials can additionally or alternatively be in the form of metal acetates, sulfates, sulfides, nitrates, oxides, stannates, chlorides, carbonates, borates, or stearates. Particular materials suitable as functional additives include, but are not limited to, cuprous oxide, cupric acetate, cupric chloride, cupric nitrate, cupric oxide, cupric sulfate, cupric stearate, zinc stearate, zinc borate, zinc sulfate, zinc sulfide, ferrous sulfate, ammonium sulfate, copper sulfate, ferric and ferrous sulfates, zinc chloride, zinc sulfate. In some embodiments, organic materials such as benzalkonium chloride and sodium pentachlorophenate can be included as a functional additive.

The functional additive is included in the polymer-based granules in an amount of greater than about 0.5 wt. %, including amounts greater than about 0.75 wt. %, greater than about 1 wt. %, greater than about 2 wt. %, greater than about 3 wt. %, greater than about 5 wt. %, or greater than about 7 wt. % based on a total weight of the polymer-based granules, including any numbers and end points therebetween. The functional additive is included in an amount of less than about 80 wt. %, less than about 70 wt. %, less than about 60 wt. %, less than about 50 wt. %, less than about 40 wt. %, less than about 30 wt. %, or less than about 20 wt. %, including an amount less than about 18 wt. %, less than about 15 wt. %, less than about 12 wt. %, less than about 10 wt. %, less than about 9 wt. %, less than about 8 wt. %, less than about 5 wt. %, or less than about 4 wt. %, based on a total weight of the polymer-based granules, including any numbers and end points therebetween. For example, the functional additive can be included in the polymer-based granules in an amount of from greater than about 0.75 wt. % to about 80 wt. %, from about 0.75 wt. % to about 50 wt. %, from about 0.75 wt. % to about 30 wt. %, or from about 0.75 wt. % to about 20 wt. %, including, for example, from about 0.75 wt. % to about 18 wt. %, from about 0.75 wt. % to about 15 wt. %, from about 0.75 wt. % to about 12 wt. %, from about 0.75 wt. % to about 10 wt. %, from about 0.75 wt. % to about 9 wt. %, from about 0.75 wt. % to about 8 wt. %, from about 0.75 wt. % to about 5 wt. %, from about 0.75 wt. % to about 4 wt. %, from about 1 wt. % to about 20 wt. %, from about 1 wt. % to about 18 wt. %, from about 1 wt. % to about 15 wt. %, from about 1 wt. % to about 12 wt. %, from about 1 wt. % to about 10 wt. %, from about 1 wt. % to about 9 wt. %, from about 1 wt. % to about 8 wt. %, from about 1 wt. % to about 5 wt. %, from about 1 wt. % to about 4 wt. %, from about 2 wt. % to about 20 wt. %, from about 2 wt. % to about 18 wt. %, from about 2 wt. % to about 15 wt. %, from about 2 wt. % to about 12 wt. %, from about 2 wt. % to about 10 wt. %, from about 2 wt. % to about 9 wt. %, from about 2 wt. % to about 8 wt. %, from about 2 wt. % to about 5 wt. %, from about 2 wt. % to about 4 wt. %, from about 3 wt. % to about 20 wt. %, from about 3 wt. % to about 18 wt. %, from about 3 wt. % to about 15 wt. %, from about 3 wt. % to about 12 wt. %, from about 3 wt. % to about 10 wt. %, from about 3 wt. % to about 9 wt. %, from about 3 wt. % to about 8 wt. %, from about 3 wt. % to about 5 wt. %, or from about 3 wt. % to about 4 wt. %, based on a total weight of the polymer-based granules, including any ranges and subranges included therein.

It has been discovered that a filler material may be used to control the leaching of the functional additive from the polymer-based granule and can also increase fire retardancy of the shingle. The filler can be, for example, a mineral filler or other fillers known and used in the art. By way of non-limiting example, the mineral filler can be limestone, dolomite, fly ash, talc, calcium carbonate, kaolin, wollastonite, glass, nanofillers, silica, barium sulfate, zinc oxide, titanium dioxide, aluminum hydroxide, fumed silica, carbon black, magnesium hydroxide, diatomaceous earth, perlite, ball clay, iron oxide, and combinations or mixtures thereof. Other suitable fillers can include, by way of example and not limitation, sodium sulfate, mica, calcium silicate, calcium sulfate, precipitated silica, quartz, aluminum trihydrate, ammonium polyphosphate, colemanite, ground tire rubber, basalt, graphite, and combinations or mixtures thereof.

The filler can be included in an amount of greater than or equal to 1 wt. %, including, for example, greater than or equal to about 5 wt. %, greater than or equal to about 10 wt. %, greater than or equal to about 15 wt. %, greater than or equal to about 20 wt. %, greater than or equal to about 25 wt. %, greater than or equal to about 30 wt. %, greater than or equal to about 35 wt. %, greater than or equal to about 40 wt. %, greater than or equal to about 45 wt. %, or greater than or equal to about 50 wt. %, based on a total weight of the polymer-based granules, including any numbers and end points therebetween. The filler can be included in an amount of less than about 80 wt. %, including an amount less than about 75 wt. %, less than about 70 wt. %, less than about 65 wt. %, less than about 60 wt. %, less than about 55 wt. %, less than about 50 wt. %, less than about 45 wt. %, less than about 40 wt. %, less than about 35 wt. %, less than about 30 wt. %, less than about 25 wt. %, less than about 20 wt. %, or less than about 15 wt. %, based on a total weight of the polymer-based granules, including any numbers and end points therebetween. For example, the filler can be included in the polymer-based granules in an amount of from about 1 wt. % to about 80 wt. %, from about 1 wt. % to about 75 wt. %, from about 1 wt. % to about 70 wt. %, from about 1 wt. % to about 65 wt. %, from about 1 wt. % to about 60 wt. %, from about 1 wt. % to about 55 wt. %, from about 1 wt. % to about 50 wt. %, from about 1 wt. % to about 45 wt. %, from about 1 wt. % to about 40 wt. %, from about 1 wt. % to about 35 wt. %, from about 1 wt. % to about 30 wt. %, from about 1 wt. % to about 25 wt. %, from about 1 wt. % to about 20 wt. %, from about 5 wt. % to about 80 wt. %, from about 5 wt. % to about 75 wt. %, from about 5 wt. % to about 70 wt. %, from about 5 wt. % to about 65 wt. %, from about 5 wt. % to about 60 wt. %, from about 5 wt. % to about 55 wt. %, from about 5 wt. % to about 50 wt. %, from about 5 wt. % to about 45 wt. %, from about 5 wt. % to about 40 wt. %, from about 5 wt. % to about 35 wt. %, from about 5 wt. % to about 30 wt. %, from about 5 wt. % to about 25 wt. %, from about 5 wt. % to about 20 wt. %, from about 10 wt. % to about 80 wt. %, from about 10 wt. % to about 75 wt. %, from about 10 wt. % to about 70 wt. %, from about 10 wt. % to about 65 wt. %, from about 10 wt. % to about 60 wt. %, from about 10 wt. % to about 55 wt. %, from about 10 wt. % to about 50 wt. %, from about 10 wt. % to about 45 wt. %, from about 10 wt. % to about 40 wt. %, from about 10 wt. % to about 35 wt. %, from about 10 wt. % to about 30 wt. %, from about 10 wt. % to about 20 wt. %, from about 15 wt. % to about 80 wt. %, from about 15 wt. % to about 75 wt. %, from about 15 wt. % to about 70 wt. %, from about 15 wt. % to about 65 wt. %, from about 15 wt. % to about 60 wt. %, from about 15 wt. % to about 55 wt. %, from about 15 wt. % to about 50 wt. %, from about 15 wt. % to about 45 wt. %, from about 15 wt. % to about 40 wt. %, from about 15 wt. % to about 35 wt. %, or from about 15 wt. % to about 30 wt. % based on a total weight of the polymer-based granules, including any ranges and subranges included therein. However, in some embodiments, the filler is not included in the polymer-based granules. Accordingly, in various embodiments, the filler is an optional component.

The filler is comprised of particles having a particular median particle size. In some embodiments, the filler comprises particles having a median particle size of greater than about 1.0 μm, including, for example, greater than about 1.5 μm, greater than about 2.0 μm, greater than about 2.5 μm, greater than about 3 μm, or greater than about 3.5 μm, including any numbers and end points therebetween, as measured in accordance with ISO 13322-2. In some embodiments, the filler comprises particles having a median particle size of greater than about 10 μm, including, for example, greater than about 15 μm, greater than about 25 μm, greater than about 30 μm, greater than about 50 μm, greater than about 75 μm, greater than about 100 μm, greater than about 125 μm, greater than about 150 μm, greater than about 175 μm, greater than about 200 μm, greater than about 250 μm, greater than about 300 μm, greater than about 350 μm, or greater than about 400 μm, including any numbers and end points therebetween, as measured in accordance with ISO 13322-2. In some embodiments, the particles of the filler have a median particle size of less than about 500 μm, including, for example, less than about 450 μm, less than about 400 μm, less than about 350 μm, less than about 300 μm, less than about 250 μm, less than about 200 μm, less than about 175 μm, less than about 150 μm, less than about 125 μm, less than about 100 μm, less than about 75 μm, less than about 50 μm, less than about 30 μm, less than about 25 μm, less than about 15 μm, or less than about 10 μm. In some embodiments, the particles of the filler have a median particle size of less than about 5.0 μm, including, for example, less than about 4.5 μm, less than about 4.0 μm, or less than about 3.5 μm, including any numbers and end points therebetween, as measured in accordance with ISO 13322-2. For example, the particles of the filler can have a median particle size of from about 1.0 μm to about 5.0 μm, from about 1.0 μm to about 4.5 μm, from about 1.0 μm to about 4.0 μm, from about 1.0 μm to about 3.5 μm, from about 1.5 μm to about 5.0 μm, from about 1.5 μm to about 4.5 μm, from about 1.5 μm to about 4.0 μm, from about 1.5 μm to about 3.5 μm, from about 2.0 μm to about 5.0 μm, from about 2.0 μm to about 4.5 μm, from about 2.0 μm to about 4.0 μm, from about 2.0 μm to about 3.5 μm, from about 2.5 μm to about 5.0 μm, from about 2.5 μm to about 4.5 μm, from about 2.5 μm to about 4.0 μm, or from about 2.5 μm to about 3.5 μm, including any and all ranges and subranges therein, as measured in accordance with ISO 13322-2. In other embodiments, the particles of the filler can have a median particle size of from about 5.0 μm to about 500 μm, from about 5.0 μm to about 400 μm, from about 5.0 μm to about 300 μm, from about 5.0 μm to about 200 μm, from about 5.0 μm to about 150 μm, from about 5.0 μm to about 100 μm, from about 5.0 μm to about 75 μm, from about 5.0 μm to about 50 μm, from about 5.0 μm to about 25 μm, from about 10 μm to about 500 μm, from about 10 μm to about 400 μm, from about 10 μm to about 300 μm, from about 10 μm to about 200 μm, from about 10 μm to about 150 μm, from about 10 μm to about 100 μm, from about 10 μm to about 75 μm, from about 10 μm to about 50 μm, from about 10 μm to about 25 μm, from about 25 μm to about 500 μm, from about 25 μm to about 400 μm, from about 25 μm to about 300 μm, from about 25 μm to about 200 μm, from about 25 μm to about 150 μm, from about 25 μm to about 100 μm, from about 25 μm to about 75 μm, from about 25 μm to about 50 μm, from about 50 μm to about 500 μm, from about 50 μm to about 400 μm, from about 50 μm to about 300 μm, from about 50 μm to about 200 μm, from about 50 μm to about 150 μm, from about 50 μm to about 100 μm, from about 50 μm to about 75 μm, from about 100 μm to about 500 μm, from about 100 μm to about 400 μm, from about 100 μm to about 300 μm, or from about 100 μm to about 200 μm, including any and all ranges and subranges therein, as measured in accordance with ISO 13322-2.

The particle size of the filler may be selected to tailor or control the amount of leaching of the functional additive from the polymer-based granules. In embodiments including a filler having a median particle size of less than 5.0 μm, the polymer-based granules may have a decreased leach rate, such as a leach rate of less than 100 ppm of functional additive per gram of polymer-based granule after 3000 hours of aging in accordance with ASTM D4798. For example, the polymer-based granules including a filler having a median particle size of less than 5.0 μm may leach less than about 100 ppm, less than about 90 ppm, less than about 80 ppm, less than about 70 ppm, less than about 60 ppm, or less than about 50 ppm, including any numbers and end points therebetween, of functional additive per gram of polymer-based granule after 3000 hours of aging in accordance with ASTM D4798.

In embodiments including a filler having a median particle size of greater than 5.0 μm, the polymer-based granules may have an increased leach rate, such as a leach rate of greater than 100 ppm of functional additive per gram of polymer-based granule after 3000 hours of aging in accordance with ASTM D4798. For example, the polymer-based granules including a filler having a median particle size of greater than 5.0 μm can leach greater than about 100 ppm, greater than about 110 ppm, greater than about 125 ppm, greater than about 150 ppm, greater than about 175 ppm, greater than about 200 ppm, greater than about 225 ppm, greater than about 250 ppm, greater than about 275 ppm, or greater than about 300 ppm, including any numbers and end points therebetween, of functional additive per gram of polymer-based granule after 3000 hours of aging in accordance with ASTM D4798.

It has been surprisingly discovered that the rate of leaching of the functional additive from the polymer-based granules may be further controlled by the particular type of fillers included in the granules. For example, fillers having higher water solubility can make the filler dissolve faster when exposed to water which, in turn, would expose the underlying polymer to the ultraviolet (UV) rays, thereby increasing the rate of degradation of the polymer. In contrast, fillers with a lower water solubility can enable the filler to protect the polymer longer from the UV rays, thereby decreasing the rate of degradation of the polymer. As a result, the leach rate of functional additive from the polymer-based granule can be slowed. Accordingly, as compared to a conventional roofing granule including a calcium carbonate filler or a conventional polymer-based granule, incorporating a filler having a water solubility that is lower than the water solubility of calcium carbonate (e.g., barium sulfate, SiO₂, TiO₂) into a polymer-based granule can be effective to reduce the leaching rate of the functional additive from the polymer-based granules. In contrast, in embodiments in which an increased leaching rate is desired, incorporating a filler having a water solubility that is greater than the water solubility of calcium carbonate into a polymer-based granule can be effective to adjust the leaching rate in the desired fashion.

Optionally, the polymer-based granules can also include a UV blocker, absorber, quencher, or stabilizer. When included, a UV blocker, absorber, quencher, or stabilizer can reduce photodegradation of granules, thereby reducing or preventing cracking, retaining color or improving color retention, and extending the life of the granule. Inclusion of a UV blocker in the polymer-based granules can also be used to tailor and control the amount of leaching of the functional additive from the polymer-based granules. More particularly, in embodiments including at least 0.25 wt. % of a UV blocker, the polymer-based granules may exhibit a decreased leach rate, such as a rate of less than 100 ppm of functional additive per gram of polymer-based granule after 3000 hours of aging in accordance with ASTM D4798. UV blocker, absorber, quencher, or stabilizer can include, by way of example and not limitation, benzotrazoles, benzophenones, organic nickel compounds, hydroxyphenyl triazines, oxanilides, cyanoacrylates, hydroxyphenyl benzotriazoles, hindered amine light stabilizers, carbon black, titanium dioxide, and other UV blockers known and used in the art. When included in the polymer-based granules, the UV blocker, absorber, quencher, or stabilizer can be included in an amount of greater than 0 wt. % to about 10 wt. %, or from about 0.25 wt. % to about 5 wt. %, based on a total weight of the polymer-based granules, including any ranges and subranges included therein.

Optionally, the polymer-based granules can also include other components such as curing agents or hardeners, extenders, flow modifiers, antioxidants, thermal stabilizers, compatibilizers, other thermoplastics, flame retardants, inorganic pigments, and the like. Any of these optional, additional components can be included in the polymer-based granules in an amount of greater than 0 wt. % to about 20 wt. %, such as from about 0.5 wt. % to about 15 wt. % or from about 1 wt. % to about 10 wt. %, including any ranges and subranges included therein. The particular combination of additives and the amounts thereof vary depending on the particular embodiment.

As mentioned below, the polymer-based granule is tunable, whereby one or more selections can be made to either increase or decrease the functional additive leach rate. Particularly, to increase the functional additive leach rate of at least 100 ppm of functional additive per gram of the polymer-based granule after 3000 hours of aging according to ASTM D4798, one or more of the following selections may be made: 1) selecting a filler comprising a plurality of particles having a median particle size of greater than 5 microns; and/or 2) selecting a polymer carrier material that comprises polypropylene. Polymer-based granules formed including at least one selection may have a leach rate greater than about 100 ppm, including, for example, greater than about 110 ppm, greater than about 125 ppm, greater than about 150 ppm, greater than about 175ppm, greater than about 200 ppm, greater than about 225 ppm, greater than about 250 ppm, greater than about 275 ppm, or greater than about 300 ppm of functional additive per gram of polymer-based granule after 3000 hours of aging in accordance with ASTM D4798, including all endpoints and subranges therebetween.

In contrast, to decrease the functional additive leach rate and/or achieve a leach rate no greater than 100 ppm of functional additive per gram of the polymer-based granule after 3000 hours of aging according to ASTM D4798, one or more of the following selections may be made: 1) selecting a polymer carrier material that comprises polyethylene; 2) incorporating at least 0.25 wt. % of a UV blocking agent in the polymer-based granule; and/or 3) utilizing a mineral filler having a median particle size of 1 to 5 microns. Polymer-based granules formed including at least one selection above may leach less than about 100 ppm, less than about 90 ppm, less than about 80 ppm, less than about 70 ppm, less than about 60 ppm, or less than about 50 ppm, of functional additive per gram of polymer-based granule after 3000 hours of aging in accordance with ASTM D4798, including all endpoints and subranges therebetween.

The polymer-based granules may be formed by first mixing a powder or granulated mixture including the functional additive, the filler, and any additional additive (e.g., UV blockers, flame retardants, etc.) to form a mixture. The mixing can be carried out, for example, using a ball mill, vortex mixer, attritor milling, or any other mixing method or apparatus commonly known and used in the art. In some embodiments, the functional additive, filler, and any additional additive can be added to the extruder to form the powder mixture. The mixture can then optionally be dried in an oven at a temperature of 100° C. to remove moisture ahead of extrusion.

Next, the powder mixture may be extruded with the polymer carrier to form a polymer composite. In any of the exemplary embodiments, the co-extrusion can be carried out using a twin-screw extruder, although other extrusion methods known in the art can be used depending on the particular embodiment. The polymer composite is pulled from the twin-screw extruder and chopped to produce pellets of a defined width, length, height, and density. In any of the embodiments, the pellets can be cylindrical-shaped, although other sizes and shapes are known and suitable for the granules. For example, in various embodiments, each of the width, length, and diameter are independently selected to be from about 0.2 mm to about 3 mm, including from about 0.5 mm to about 2 mm, from about 0.5 mm to about 1.5 mm, or from about 0.5 mm to about 1.2 mm, including any ranges and subranges included therein. In any of the exemplary embodiments, the polymer-based granules can have a density of from about 0.3 g/mL to about 3 g/mL, including from about 0.5 g/mL to about 3 g/mL, from about 0.75 g/mL to about 2.5 g/mL, from about 0.75 g/mL to about 2 g/mL, or from about 1 g/mL to about 1.5 g/mL. It is contemplated that the particular shape and size of the polymer-based granules can vary on the specific embodiment and can be controlled using process parameters.

The resultant polymer-based granules are deposited onto the shingle in an amount suitable to provide the shingle with the desired properties. In any of the exemplary embodiments, the polymer-based granules described herein may be used as the primary or main granule on the shingle, or can be applied to the surface of the shingle at a lower percentage. As used herein, the term “primary granule” or “main granule” refers to the granule that is present in greatest amount by volume based on a total volume of the granules deposited on the shingle. For example, the polymer-based granules can be deposited at an average of 1% to 100% of the total granules, including between 2% to 75%, 5% to 60%, 8% to 50%, 10% to 40%, or about 2-10% of the total granules applied to the surface of the shingle, including any ranges and subranges included therein. Other granules, including traditional roofing granules and other specialty granules can be deposited on the surface of the shingle. These other granules can be deposited during the same or during a separate step as the deposition of the polymer-based granules described herein.

Although described herein as being deposited onto shingles, in other embodiments, the polymer-based granules can be used in any one of a variety of applications. For example, the polymer-based granules can be deposited on surfacing material for other applications, including but not limited to roads, siding, flooring, flat roofs, and the like. Various aspects disclosed herein may also be employed to formulate controlled release polymer pellets including functional additives such as biocides, algaecides, fungicide, and antimicrobial compound suitable for use in dispersing lawn/ground treatments or to reduce or prevent biological growth on textured surfaces of exterior facades, for example.

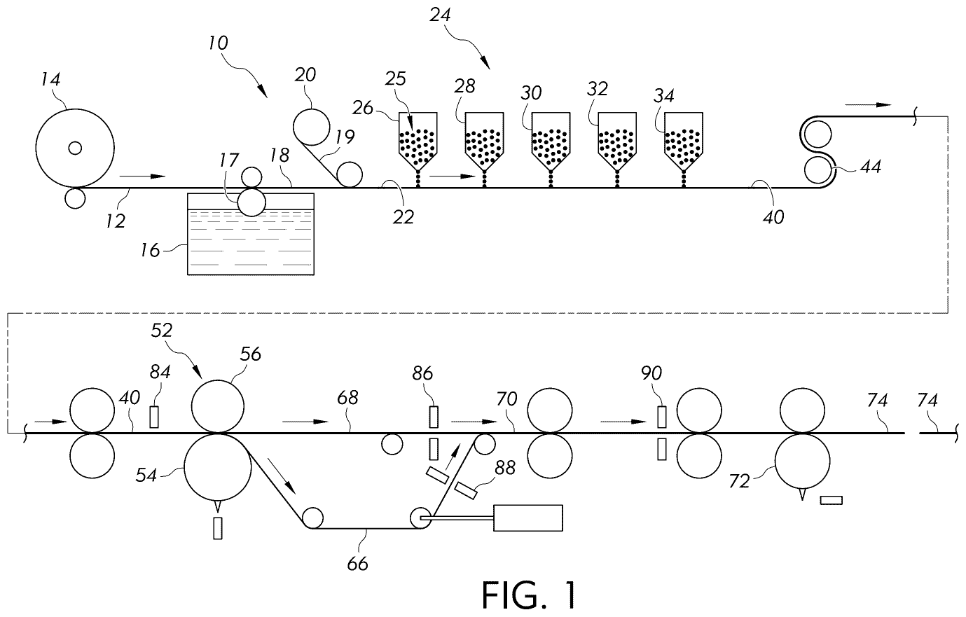

FIG. 1 illustrates an example apparatus 10 for manufacturing an asphalt-based roofing material according to a manufacturing process wherein a continuous sheet is passed in a machine direction (indicated by the arrows) through a series of manufacturing operations. The sheet can pass at a speed of at least about 200 feet/minute (61 meters/minute), and can pass at a speed within the range of between about 450 feet/minute (137 meters/minute) and about 800 feet/minute (244 meters/minute) or even at or above 1200 feet/minute. The sheet, however, can move at any desired speed.

The manufacturing process continues as the continuous sheet of substrate or shingle mat 12 is payed out from a roll 14. The substrate can be any type known for use in reinforcing asphalt-based roofing materials, such as a non-woven web of glass fibers. The shingle mat 12 is fed through a coater 16 where an asphalt coating is applied to the shingle mat 12. The asphalt coating can be applied in any suitable manner. In one example, the shingle mat 12 contacts a roller 17, which is in contact with a supply of hot, melted asphalt. The roller 17 completely covers the shingle mat 12 with a tacky coating of hot, melted asphalt to define a first asphalt coated sheet 18. Alternatively, the asphalt coating can be sprayed on, rolled on, or applied to the first asphalt coated sheet 18 by any other suitable means.

Next, and optionally, a continuous strip of a reinforcement material or reinforcement tape 19, is payed out from a roll 20. The reinforcement tape 19 adheres to the first asphalt coated sheet 18 to define a second asphalt coated sheet 22. In any of the exemplary embodiments, the reinforcement tape 19 can be attached to the first asphalt coated sheet 18 by the adhesive mixture of the asphalt in the first asphalt coated sheet 18. Alternatively, the reinforcement tape 19 can be attached to the first asphalt coated sheet 18 by any suitable means, such as other adhesives. In any of the exemplary embodiments, the reinforcement tape 19 can be formed from polyester. In other embodiments, the reinforcement tape 19 can be formed from polyolefin, such as polypropylene or polyethylene, and can include any polymeric material having the desired properties for the finished product and which endures the manufacturing environment. The reinforcement tape 19 can be formed from any material which preferably reinforces and strengthens the nail zone of a shingle, such as, by way of non-limiting example, paper, film, scrim material, and woven or non-woven fibers, such as glass, natural or polymer fibers. Alternatively, the reinforcement tape 19 can be formed of any material that does not provide such physical properties, but simply provides an indicia of the nail zone.

The second asphalt coated sheet 22 passes beneath a series of granule dispensers 24 for the application of granules to the upper surface of the second asphalt coated sheet 22. The granule dispensers 24 can be of any type suitable for depositing granules 25 onto the asphalt coated sheet. In an exemplary embodiment, a series of granule dispensers 24 can include one or more color blenders, for example, the series of granule dispensers 24 can include four color blend blenders 26, 28, 30, and 32 and a background blender 34. Any desired number of color blenders, however, can be used. Moreover, the granule dispensers 24 can dispense alternate forms of granules such as specialty granules defined below. Specialty granules, including the polymer-based granules described herein, can be applied with a separate granule dispenser or can be mixed into any of the four color blend blenders 26, 28, 30, and 32 and/or the background blender 34. Alternatively, granules 25 can be dispensed onto the second asphalt coated sheet 22 by any means suitable for dispensing granules 25. After all the granules 25 are deposited on the second asphalt coated sheet 22 by the series of granule dispensers 24, the second asphalt coated sheet 22 becomes a granule covered sheet 40.

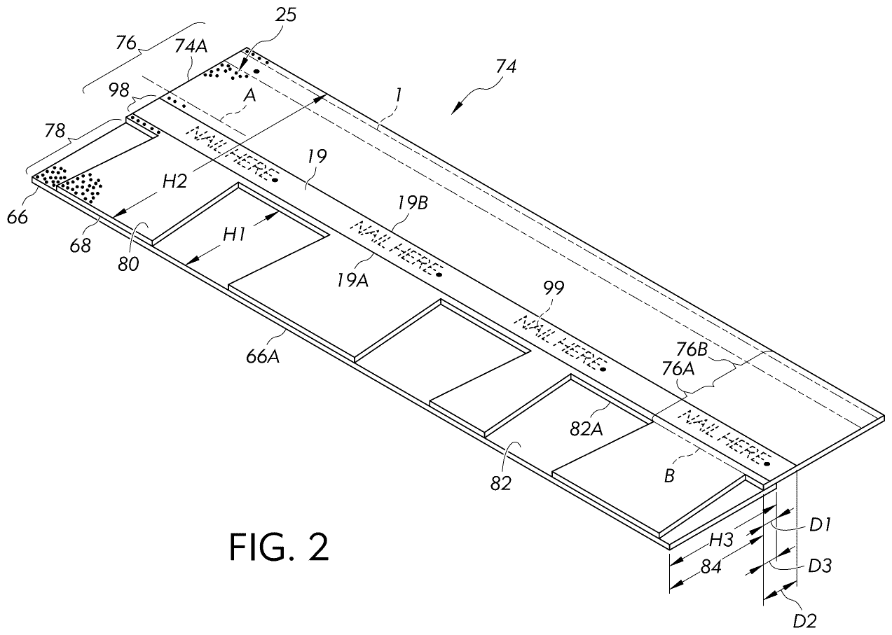

To the extent a reinforcement tape is provided, the reinforcement tape 19 can include an upper surface to which the granules 25 will not substantially adhere. The reinforcement tape 19, alternatively, can include an upper surface to which the granules 25 will adhere. For example, the apparatus 10 can include any desired means for depositing the granules 25 onto substantially the entire second asphalt coated sheet 22, except for the portion of the second asphalt coated sheet 22, covered by the reinforcement tape 19, as best shown in FIG. 2. Alternately, the granules 25 can be deposited onto substantially the entire second asphalt coated sheet 22, including the reinforcement tape 19, where the reinforcement tape 19 includes an upper surface to which the granules 25 substantially will not adhere.

The granule covered sheet 40 is turned around a slate drum 44 to press the granules 25 into the asphalt coating and to temporarily invert the granule covered sheet 40 so that the excess granules will fall off and can be recovered and reused. Next, the granule covered sheet 40 is fed through a rotary pattern cutter 52 having a bladed cutting cylinder 54 and a backup roll 56. Optionally, the pattern cutter 52 can cut a series of cutouts in the tab portion of the granule covered sheet 40, and cut a series of notches in the underlay portion of the granule covered sheet 40.

The pattern cutter 52 can also cut the granule covered sheet 40 into a continuous underlay sheet 66 and a continuous overlay sheet 68. The underlay sheet 66 can be aligned beneath the overlay sheet 68, and the two sheets 66, 68 can be laminated together to form a continuous laminated sheet 70. The continuous underlay sheet 66 can be routed on a longer path than the path of the continuous overlay sheet 68. Further downstream, the continuous laminated sheet 70 is passed into contact with a rotary length cutter 72 that cuts the laminated sheet into individual laminated shingles 74.

In order to facilitate synchronization of the cutting and laminating, various sensors and controls can be employed. For example, sensors, such as photo eyes 86 and 88 can synchronize the continuous underlay sheet 66 with the continuous overlay sheet 68. Sensors 90 can synchronize the notches and cutouts of the continuous laminated sheet 70 with the end cutter or length cutter 72.

Referring now to FIG. 2, an example laminated roofing shingle 74 is illustrated according to aspects described herein. The shingle 74 includes the overlay sheet 68 attached to the underlay sheet 66. The shingle 74 has a first end 74A, a second end 74B, and a longitudinal axis A. The overlay sheet 68 includes a headlap portion 76 and a tab portion 78. The headlap portion 76 includes a lower zone 76A and an upper zone 76B. The tab portion 78 defines a plurality of tabs 80 alternating a plurality of cutouts 82 such that each of the plurality of cutouts 82 can be located between each adjacent tab 80. By way of non-limiting example, the tab portion 78 can include four tabs 80, although any suitable number of tabs 80 can be provided. The headlap portion 76 and the tabs 80 can include one or more granule patterns thereon.

Each cutout 82 has a first height H1. As illustrated in FIG. 2, each cutout 82 has the same height H1 as another cutout 82. It will be understood, however, that each cutout 82 can have a different height H1 as another cutout 82. A line B, collinear with an upper edge 82A of the cutouts 82, defines an upper limit of an exposed region 84 of the underlay sheet 66.

In embodiments, the height of the exposed region 84 is equal to the first height H1, however, the height of the exposed region 84 may be any desired height, and the top of the cutouts 82 need not be collinear as illustrated. In a shingle 74 wherein the cutouts 82 have different first heights H1, the line B can alternatively be collinear with an upper edge 82A of the cutout 82 having the largest height H1.

The reinforcement tape 19 is located longitudinally on the headlap portion 76 from the first end 74A to the second end 74B of the shingle 74 within the lower zone 76A of the headlap portion 76. A lower edge 19A of the reinforcement tape 19 is spaced apart from the line B by a distance D1, and an upper edge 19B of the reinforcement tape 19 is spaced apart from the line B by a distance D2. By way of non-limiting example, the distance D1 is within the range of from about ¼ inch to about ¾ inch. In another example, the distance D1 is about ½ inch. In yet another example, the distance D2 is within the range of from about 1¾ inches to about 2¼ inches. In another example, the distance D2 is about 2 inches. The distances D1 and D2 can, however, be of any other desired length, including zero for D1. For example, in embodiments, the reinforcement tape 19 substantially covers the entire headlap portion 76 of the overlay sheet 68. It will be further understood, however, that one or more additional lengths of reinforcement tape 19 can be disposed longitudinally on the headlap portion 76, even outside the nail zone, such as shown by the phantom line 19′. It will be understood that the reinforcement material need not extend from the first end 74A to the second end 74B of the shingle 74, and can be disposed in one or more sections or portions on the shingle 74.

The reinforcement tape 19 can define a nail zone 98 and can optionally include indicia 99. By way of non-limiting example, the indica 99 can be text such as “nail here”, as shown in FIG. 2. It will be understood, however, that any other text or other indicia can included on the reinforcement tape 19. It will also be understood that the reinforcement tape 19 can be provided without such text or indicia. Such indicia 99 on the reinforcement tape 19 ensure that the nail zone 98 may be easily and quickly identified by the shingle installer.

The overlay sheet 68 has a second height H2. The underlay sheet 66 includes a leading edge 66A, a trailing edge 66B, and has a third height H3. The trailing edge 66B of the underlay sheet 66 is spaced apart from the line B by a distance D3. As illustrated, the distance D3 is about ⅜ inch, however, the distance D3 may be any desired distance.

The third height H3 of the underlay sheet 66 is less than one-half the second height H2 of the overlay sheet 68. The overlay sheet 68 and the underlay sheet 66 thereby define a two-layer portion of the laminated shingle 74 and a single-layer portion of the laminated shingle 74, wherein at least a portion of the reinforcement tape 19 is preferably adhered to the single-layer portion of the laminated shingle 74. Alternately, the third height H3 of the underlay sheet 66 may be equal to one-half the second height H2 of the overlay sheet 68, or greater than one-half of the second height H2 of the overlay sheet 68. Such a relationship between the underlay sheet 66 and the overlay sheet 68 allows the reinforcement tape 19 to be positioned such that a reinforced nail zone is provided at a substantially single-layer portion of the shingle 74.

In the exemplary shingle 74 illustrated in FIG. 2, the shingle 74 has a nail pull-through value, preferably measured in accordance with a desired standard, such as prescribed by ASTM test standard D3462. For example, the shingle 74 may have a nail pull-through value that is greater than in an otherwise identical shingle having no such reinforcement tape 19. The shingle 74 can have a nail pull-through value within-the range of from about ten percent to about 100 percent greater than in an otherwise identical shingle having no such reinforcement tape 19. Alternatively, the shingle 74 can have a nail pull-through value about 50 percent greater than in an otherwise identical shingle having no such reinforcement tape 19.

The granules 25 applied to the upper surface of the second asphalt coated sheet 22 can include any granule type known in the art, including conventional granules and the polymer-based granules disclosed herein.

### EXAMPLES

### Example 1

Polymer-based granules were produced using ball milling, extrusion, and pelletizing equipment, as described above. The extruder metered the polymer, functional additive, and additives at the desired percentages, provided below in Table 1.

| | | | | Functional | | |
|---|---|---|---|---|---|---|
| | Impact | | Filler | Additive | Polymer | |
| EX | Variable | Filler Type | (wt. %) | (wt. %) | (wt. %) | Polymer type |
| Ex. 3 | Pellet size | N/A | 0 | 3.6% | 96.4% | polypropylene |
| | (normal size) | | | | | |
| Ex. 4 | Pellet size | N/A | 0 | 3.6% | 96.4% | polypropylene |
| | (larger size) | | | | | |
| Ex. 5 | Filler | CaCO₃— G3 | 16.4% | 3.6% | 80% | polypropylene |
| Ex. 6 | Filler | CaCO₃— G3 | 36.4% | 3.6% | 60% | polypropylene |
| | (amount) | | | | | |
| Ex. 7 | Filler | CaCO₃— G325 | 16.4% | 3.6% | 80% | polypropylene |
| | (size) | | | | | |
| Ex. 8 | 1% UV | CaCO₃— G3 | 15.4% | 3.6% | 80% | polypropylene |
| | blocker | | | | | |
| Ex. 20 | polymer | N/A | 0 | 3.6% | 96.4% | LDPE |
| Ex. 22 | Filler type | BaSO₄ | 16.4% | 3.6% | 80% | polypropylene |

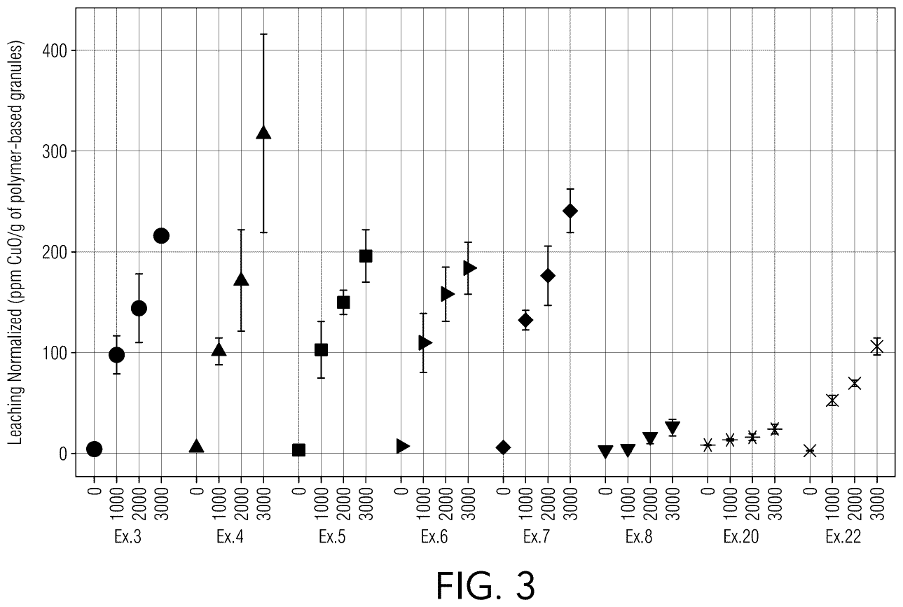

Polymer-based granules were applied to prototyped shingle samples and the leach rate was measured. To measure the leach rate, the weight of the sample was measured and the samples were aged in accordance with ASTM D4798. Following aging, the samples were each submerged in 100 mL of an 0.5% nitric acid solution for 5 days. The concentration of leached copper in the solution was measured by inductively-coupled plasma (ICP) analysis to determine the copper oxide in parts per million (ppm). The concentration was then normalized based on the initial weight of the polymer-based granule by dividing the measured concentration by the initial weight of the sample. The results are shown in FIG. 3.

By comparing the leaching rate of the various pellets to pellets that are similarly formulated, the ability to tune the leaching rate by altering the formulation of the pellets is demonstrated. For example, as illustrated in FIG. 3, a comparison of examples 3 and 4 demonstrates that as the pellet size increased, the leaching increased with aging. The inclusion of filler in examples 5 and 6 decreased the leaching as compared to example 3, which is otherwise identical but did not include filler. Comparing examples 5 and 7, the size of the filler was shown to increase leaching over time, similar to increasing the size of the pellet.

Surprisingly, in example 8, the inclusion of 1% UV blocker was effective to significantly decrease the leaching over example 5, which did not include the UV blocker but was otherwise identical. As demonstrated by example 20, replacing polypropylene with LDPE as a polymer carrier was also effective to significantly decrease the leaching as compared to example 3, which is otherwise identical to example 20. Moreover, comparing example 22 with examples 5 or 7 demonstrates that the inclusion of BaSO₄ as a filler is effective to reduce the leach rate as compared to the use of CaCO₃ as a filler.

It should be recognized that leach rates of functional additives in polymer-based granules can be adjusted based on at least polymer carrier types, inclusion of particular additives (e.g., UV blockers), and filler size, type, and amount. Accordingly, the resistance of polymer-based granules to algae, cyanobacteria, moss, fungi, and other microorganisms can be tuned to achieve particular leach rates to balance the lifespan of the polymer-based granules with the properties imparted by the functional additives. Moreover, it is contemplated that the inclusion of the polymer-based granules could render recycled asphalt more valuable in an extraction process. For example, polymers included in the polymer-based granules may enhance the performance of the recycled asphalt in end use applications, such as improving the quality of asphalt obtained from recycled asphalt shingles.

To the extent not already described, the different features and structures of the various embodiments of the present disclosure may be used in combination with each other as desired. For example, one or more of the features illustrated and/or described with respect to one aspect of the disclosure can be used with or combined with one or more features illustrated and/or described with respect to other aspects of the disclosure. That one feature may not be illustrated in all of the embodiments is not meant to be construed that it cannot be, but is done for brevity of description. Thus, the various features of the different embodiments may be mixed and matched as desired to form new embodiments, whether or not the new embodiments are expressly described.

While aspects of the present disclosure have been specifically described in connection with certain specific embodiments thereof, it is to be understood that this is by way of illustration and not of limitation. Reasonable variation and modification are possible within the scope of the forgoing disclosure and drawings without departing from the spirit of the present disclosure which is defined in the appended claims.

What is claimed is:

1. A polymer-based granule comprising:
at least 20 wt. %, based on a total weight of the polymer-based granule, of a polyolefin carrier material;
from 1 wt. % to 10 wt. %, based on a total weight of the polymer-based granule, of a functional additive comprising one or more of an algaecide, biocide, fungicide, and antimicrobial compound;
from 1 wt. % to less than 80 wt. % of a filler, based on a total weight of the polymer-based granule, wherein the filler comprises a plurality of particles having a median particle size of from 1 to 5 microns, as measured in accordance with ISO 13322-2; and
from 0.25 wt. % to 5 wt. % of a UV blocking agent, wherein the polymer-based granules leach less than 100 ppm of functional additive per gram of the polymer-based granule after 3000 hours of aging according to ASTM D4798.

2. The polymer-based granule of claim 1, wherein the polyolefin carrier material is present in the polymer-based granule in an amount of at least 60 wt. %, and the filler is present in the polymer-based granule in an amount of from 5 to less than 40 wt. %, based on the total weight of the polymer-based granule.

3. The polymer-based granule of claim 2, wherein the filler comprises a plurality of particles having a median particle size of 2.5 to 4 microns, as measured in accordance with ISO 13322-2.

4. The polymer-based granule of claim 1, wherein the polymer carrier material comprises high density polyethylene, ultra-high density polyethylene, low density polyethylene, polyethylene terephthalate, polypropylene, polystyrene, PVC, acrylonitrile butadiene styrene (ABS), polyamides, polyesters, polycarbonate, polyvinyl chloride, polymethyl methacrylate, polyglycolic acid, polyhydroxy butyrate, polyurethanes, polyureas, epoxy, polydimethylsiloxane (PDMS), poly(styrene-butadiene-styrene) (SBR), styrene butadiene rubber (SBR), styrene-(ethylene/butylene)-crystalline block copolymer (SEBC), acrylic, atactic polypropylene, polyvinyl butyral, asphalt, recycled asphalt, or mixtures thereof.

5. The polymer-based granule of claim 1, wherein the filler comprises at least one of limestone, dolomite, fly ash, talc, barium sulfate, zinc oxide, calcium carbonate, kaolin, wollastonite, glass, nanofillers, silica, titanium dioxide, aluminum hydroxide, fumed silica, carbon black, magnesium hydroxide, diatomaceous earth, perlite, ball clay, iron oxide, sodium sulfate, mica, calcium silicate, precipitated silica, quartz, aluminum trihydrate, ammonium polyphosphate, colemanite, ground tire rubber, basalt, graphite, and combinations or mixtures thereof.

6. The polymer-based granule of claim 1, wherein the filler is present in the polymer-based granule in an amount of from about 10 wt. % to about 30 wt. % based on the total weight of the polymer-based granule.

7. The polymer-based granule of claim 6, wherein the filler comprises a plurality of particles having a median particle size of 2.5 to 4 microns, as measured in accordance with ISO 13322-2.

8. The polymer-based granule of claim 1, wherein the functional additive comprises copper oxide, zinc oxide, or a mixture thereof.

9. The polymer-based granule of claim 1, wherein the at least one functional additive is present in an amount of from about 0.75 wt. % to 4 wt. % based on the total weight of the polymer-based granule.

10. The polymer-based granule of claim 1, wherein the filler comprises a plurality of particles having a median particle size of 2.5 to 4 microns, as measured in accordance with ISO 13322-2.

11. A method of adjusting the functionality of a polymer-based granule, the method comprising:
forming a polymer-based granule by combining:
at least 20 wt. %, based on the total weight of the polymer-based granule, of a polyolefin carrier material;
from 1 wt. % to 10 wt. %, based on the total weight of the polymer-based granule, of at least one functional additive comprising one or more of an algaecide, biocide, fungicide, and antimicrobial compound; and
from 1 wt. % to less than 80 wt. % of a filler, based on a total weight of the polymer-based granule,
adjusting a functional additive leach rate to achieve a leach rate of less than 100 ppm of functional additive per gram of the polymer-based granule after 3000 hours of aging according to ASTM D4798 by performing at least one of the following steps:
forming the polymer-based granule with a polyethylene polymer carrier material;
incorporating at least 0.25 wt. % of a UV blocking agent in the polymer-based granule; or
utilizing a filler having a median particle size of 1 to 5 microns, as measured in accordance with ISO 13322-2.

12. The method of claim 11, wherein the polyolefin carrier material is present in the polymer-based granule in an amount of at least 60 wt. %, and the filler is present in the polymer-based granule in an amount of from 5 wt. % to less than 40 wt. %, based on the total weight of the polymer-based granule.

13. The method of claim 12, wherein the filler comprises a plurality of particles having a median particle size of 2.5 to 4 microns, as measured in accordance with ISO 13322-2.

14. The method of claim 11, wherein the filler comprises at least one of limestone, dolomite, fly ash, talc, barium sulfate, zinc oxide, calcium carbonate, kaolin, wollastonite, glass, nanofillers, silica, titanium dioxide, aluminum hydroxide, fumed silica, carbon black, magnesium hydroxide, diatomaceous earth, perlite, ball clay, iron oxide, sodium sulfate, mica, calcium silicate, precipitated silica, quartz, aluminum trihydrate, ammonium polyphosphate, colemanite, ground tire rubber, basalt, graphite, and combinations or mixtures thereof.

15. The method of claim 11, wherein the filler is present in the polymer-based granule in an amount of from about 10 wt. % to about 30 wt. % based on the total weight of the polymer-based granule.

16. The method of claim 15, wherein the filler comprises a plurality of particles having a median particle size of 2.5 to 4 microns, as measured in accordance with ISO 13322-2.

17. The method of claim 11, wherein the functional additive comprises copper oxide, zinc oxide, or mixtures thereof.

18. The method of claim 11, wherein the at least one functional additive is present in an amount of from about 0.75 wt. % to 4 wt. % based on the total weight of the polymer-based granule.

19. The method of claim 11, wherein the filler comprises a plurality of particles having a median particle size of 2.5 to 4 microns, as measured in accordance with ISO 13322-2.
